(19) United States
(12) Patent Application Publication
(10) Pub. No.: US 2009/0153431 A1
(43) Pub. Date: Jun. 18, 2009

(54) Continuously Tunable Impedance Matching Network Using BST Capacitor

(75) Inventor: Nan Ni, Goleta, CA (US)

Correspondence Address: FENWICK & WEST LLP, SILICON VALLEY CENTER, 801 CALIFORNIA STREET, MOUNTAIN VIEW, CA, 94041, US

(73) Assignee: AGILE RF, INC., Goleta, CA (US)

(21) Appl. No.: 12/274,927

(22) Filed: Nov. 20, 2008

Related U.S. Application Data
(60) Provisional application No. 61/013,163, filed on Dec. 12, 2007.

(51) Int. Cl. H01Q 1/50

(52) U.S. Cl. 343/861

(57) ABSTRACT

An impedance matching circuit employs a variable capacitor, such as a BST capacitor. The bias voltage to the variable capacitor may be adjusted in order to match several different frequencies used with the antenna to the signal source.

### CROSS-REFERENCE TO RELATED APPLICATION

This application claims priority under 35 U.S.C. §119(e) from co-pending U.S. Provisional Patent Application No. 61/013,163, entitled “Continuously Tunable Matching Network Using BST Capacitor,” filed on Dec. 12, 2007, which is incorporated by reference herein in its entirety.

### BACKGROUND OF THE INVENTION

1. Field of the Invention

The present invention relates to tunable impedance matching networks.

2. Description of the Related Art

Impedance matching is used to match the impedance of a source (usually 50 Ohm) with the impedance of a load circuit, such as antennas. Matching the impedances of the source and load enables the maximum amount of power to be transferred from the source to the load, or vice versa.

Many conventional matching networks have been proposed to match a single frequency of antennas to the source. After matching the antenna for the frequency of interest, it is sometimes necessary to match the antenna to 50 Ohm for another frequency, which is close to the frequency of interest.

Conventional tunable impedance matching circuits are typically comprised of capacitors, fixed and variable inductors, and/or transmission line sections. Variable inductors and transmission line sections are typically realized as switched components so that electrical connection of a fixed inductor or a transmission line section can be changed with the aid of one or more switches. However, in general the circuitry of conventional impedance matching networks may be complex and are not tunable in a convenient manner.

### SUMMARY OF THE INVENTION

Embodiments of the present invention include an impedance matching circuit that employs a variable capacitor, such as a BST capacitor. The bias voltage to the variable capacitor may be adjusted in order to tune the impedance matching network and thereby match several different frequencies used with the antenna to the signal source.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the embodiments of the present invention can be readily understood by considering the following detailed description in conjunction with the accompanying drawings.

FIG. 1 illustrates typical antenna impedance on a Smith Chart.

FIG. 2A illustrate an antenna impedance matching network according to one embodiment of the present invention.

FIG. 2B illustrates the tuning directions of the inductors L1, L2, and the BST capacitor of the antenna impedance matching network of FIG. 2A.

FIG. 3A illustrates an antenna impedance matching network according to another embodiment of the present invention.

FIG. 3B illustrates the tuning directions of the inductor L1, the capacitor C1, and the BST capacitor of the antenna impedance matching network of FIG. 3A.

FIG. 4A illustrates a tuning trace of frequency Fre1 when using the antenna matching network according to the embodiment shown in FIG. 2A.

FIG. 4B illustrates a tuning trace of frequency Fre3 when using the antenna matching network according to the embodiment shown in FIG. 2A.

FIG. 5 illustrates simulated antenna impedance without an impedance matching network.

FIG. 6 illustrates frequency Fre1 being matched to 50 Ohm when the BST capacitor is the dominant component in an impedance matching network of FIG. 2A or FIG. 3A.

FIG. 7 illustrates frequency Fre3 being matched to 50 Ohm when the inductor L1 is the dominant component in an impedance matching network of FIG. 2A or FIG. 3A.

FIG. 8 illustrates a typical metal-insulator-metal (MIM) parallel plate configuration of a thin film BST capacitor according to one embodiment of the present invention.

FIG. 9A is a graph illustrating a typical tuning curve for the BST capacitor of FIG. 8.

FIG. 9B is an equivalent circuit model for the BST capacitor of FIG. 8.

### DETAILED DESCRIPTION OF EMBODIMENTS

The Figures (FIG.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

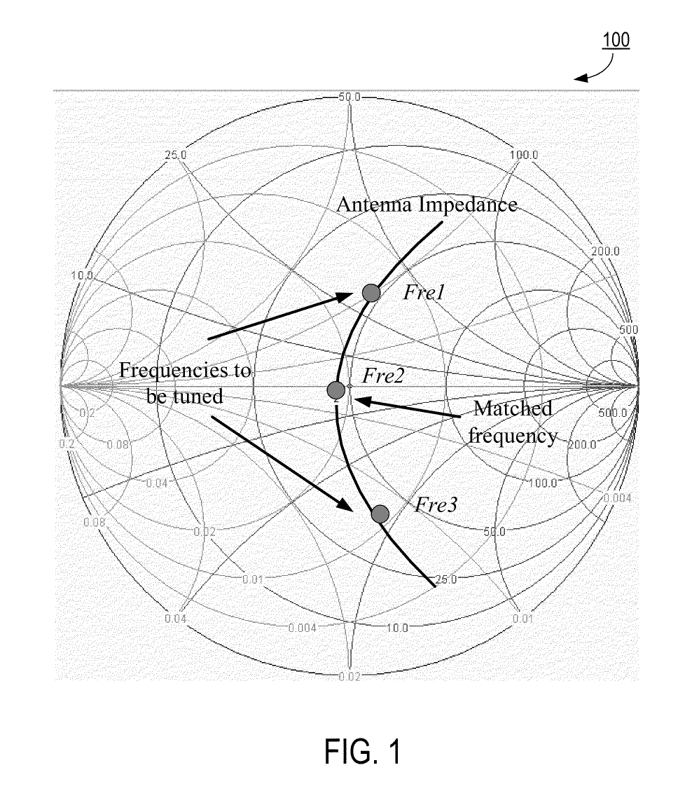

FIG. 1 illustrates typical antenna impedance on a Smith Chart. The Smith chart 100 is normalized such that the center of the Smith chart corresponds to 50 Ohm, a typical impedance of a signal source. Referring to FIG. 1, Fre2 represents the impedance of a single frequency which is close enough to 50 Ohm and considered matched. Two other frequencies (Fre1 and Fre3) were also chosen on either side of Fre2. These two frequencies (Fre1 and Fre3) are not considered matched to 50 Ohm since their impedances are not close enough to the center (50 Ohm). Two matching networks according to embodiments of the present invention and how to use them to match Fre1 and Fre3 to 50 Ohm are illustrated below.

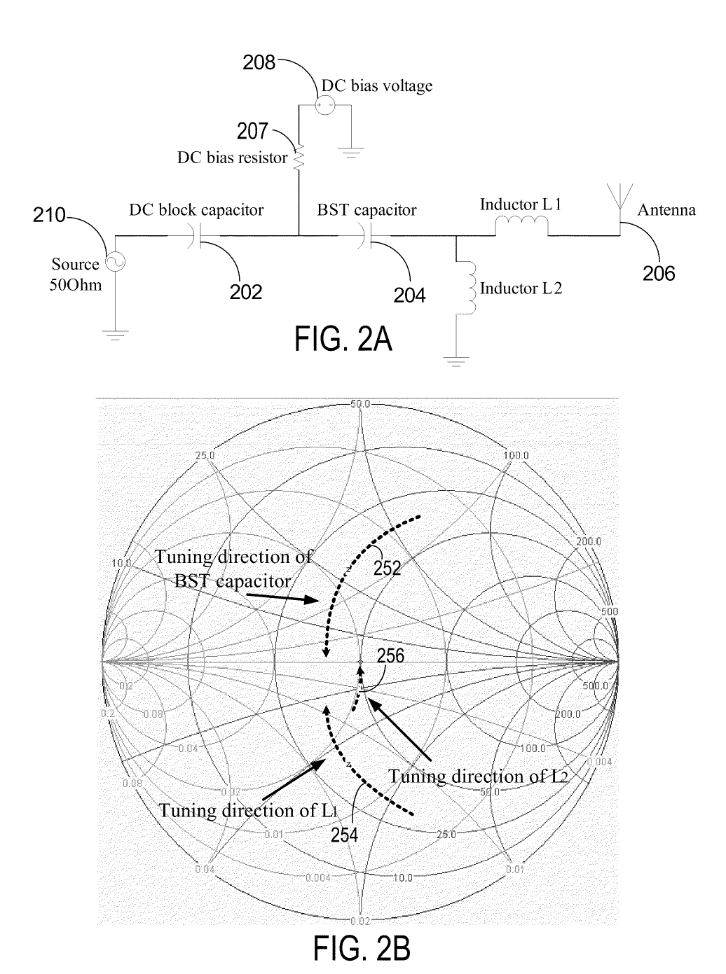

FIG. 2A illustrate an antenna matching network according to one embodiment of the present invention. The impedance matching network includes a fixed inductor L1, a fixed inductor L2 (which can be replaced by a fixed capacitor C1 (not shown)), a variable BST (Barium Strontium Titanate) capacitor 204, a DC bias voltage 208, a DC bias resistor 207, and a DC blocking capacitor 202, together matching the impedance (50 Ohm) of the source 210 with the impedance of the antenna 206. The DC bias voltage 208 is used to provide and adjust DC voltage to BST capacitor 204 through the DC bias resistor 207. The DC blocking capacitor 202 is used to block the DC voltage 208 from reaching the source 210. DC blocking capacitor 202 is connected to source 210 on one end and to DC bias voltage 208 (via DC bias resistor 207) and BST capacitor 204 on another end.

Inductors L1, L2, and BST capacitor 204 work together to tune the impedance of the antenna 206 to the impedance 50 Ohm of the source 210 by varying the capacitance value of the BST capacitor 204. Inductor L1 is connected in series with antenna 206. Inductor L2 is connected to a node between inductor L1 and BST capacitor 204 on one end and to ground another end. BST capacitor 204 is connected to inductor L1 and inductor L2 on one end and to DC blocking capacitor 202 and DC bias voltage 208 (via DC bias resistor 207) on another end. In the embodiment of FIG. 2A, variable BST capacitor 204 is connected in series with the signal source 210, and inductor L1 is also connected in series with BST capacitor 204, and both BST capacitor 204 and inductor L1 are connected in series with source 210 and antenna 206.

BST ((Barium Strontium Titanate) generally has a high dielectric constant so that large capacitances can be realized in a relatively small area. Furthermore, BST has a permittivity that depends on the applied electric field. As a result, voltage-variable capacitors (varactors) can be produced, with the added flexibility that their capacitance can be tuned by changing a DC bias voltage across the BST capacitor. Thus, the capacitance of BST capacitor 204 and thus the impedance of the matching network of FIG. 2A may be adjusted simply by adjusting the DC bias voltage 208 applied to the tunable BST capacitor 204 through the DC bias resistor 207. Since the DC blocking capacitor 202 blocks the DC bias voltage 208 to the source 210, the source 210 is not interfered by the DC voltage 208.

FIG. 2B illustrates the tuning directions of the inductors L1, L2, and the BST capacitor of the antenna matching network of FIG. 2A. As shown in FIG. 2B, the BST capacitor 204 is mainly used to move down 252 the antenna impedance along the resistance circle on the Smith chart. The inductor L1 is mainly used to move up 254 the antenna impedance along the resistance circle on the Smith chart. It can be seen that the inductor L1 and the BST capacitor 204 move the antenna impedance in opposite directions on the Smith chart. If the BST capacitor 204 has a small capacitance value, the BST capacitor 204 itself will be the dominant tuning component in the matching network and the main trend of the matching network will be to move down 252 the antenna impedance on the Smith chart. If BST capacitor 204 has a big capacitance value, inductor L1 will be the dominant tuning component in the matching network and the main trend of the matching network will be to move up 254 the antenna impedance. The inductor L2 can be used to further tune 256 the impedance along the conductance circle on the Smith chart, so that the impedance can be moved close enough to 50 Ohm (center of the Smith chart). If inductors L1 and L2 of FIG. 2A are fixed components, once the inductance values of inductors L1 and L2 are fixed such that the impedance of antenna 206 is moved closer to the center of the Smith chart, only BST capacitor 204 remains as the tunable to move the impedance of antenna 206 exactly to the center of the Smith chart and match the impedance of antenna 206 to the 50 ohm source impedance. As a result, the combined impedance of the antenna 206 and the impedance matching network of FIG. 2A can be matched to the impedance of the source 210.

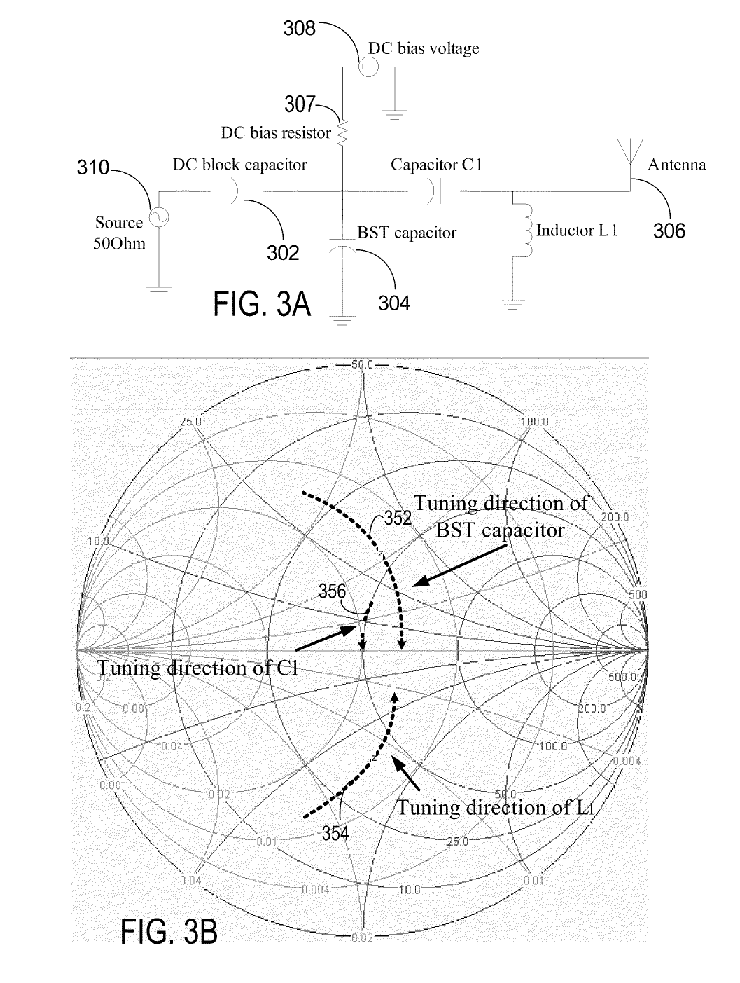

FIG. 3A illustrates an antenna matching network according to another embodiment of the present invention. The matching network includes a fixed inductor L1, a fixed capacitor C1 (which can be replaced by a fixed inductor L2 (not shown)), a variable BST capacitor 304, a DC bias voltage 308, a DC bias resistor 307, and a DC blocking capacitor 302, together matching the impedance (50 Ohm) of the signal source 310 with the impedance of the antenna 306. The DC bias voltage 308 is used to provide and adjust the DC voltage to BST capacitor 304 through the DC bias resistor 307. The DC blocking capacitor 302 is used to block the DC bias voltage 308 from reaching the signal source 310, so that the signal source 310 is not interfered by the DC voltage 308. DC blocking capacitor 302 is connected to source 310 on one end and to DC bias voltage 308 (via DC bias resistor 307) and BST capacitor 304 on another end.

Inductor L1, capacitor C1, and BST capacitor 304 work together to tune the impedance of the antenna 306 to the impedance 50 Ohm of the source 310 by varying the capacitance value of the BST capacitor 304. Inductor L1 is connected to antenna 306 and to capacitor C1 on one end and to ground on another end. Capacitor C1 is connected to a node between inductor L1 and antenna 306 on one end and to a node between BST capacitor 304, DC blocking capacitor 302, and DC bias resistor 307 on another end. BST capacitor 304 is connected to DC blocking capacitor 302, DC bias resistor 307, and capacitor C1 on one end and to ground on another end. In the embodiment of FIG. 3A, variable BST capacitor 304 is connected in parallel with the signal source 310, and inductor L1 is also connected in parallel with BST capacitor 304, and both BST capacitor 304 and inductor L1 are connected in parallel with source 310 and with antenna 306.

FIG. 3B illustrates the tuning directions of the inductor L1, the capacitor C1, and the BST capacitor of the antenna matching network of FIG. 3A. The BST capacitor 304 is mainly used to move down 352 the antenna impedance along the conductance circle on the Smith chart. The inductor L1 is mainly used to move up 354 the antenna impedance along the conductance circle on the Smith chart. Again, inductor L1 and BST capacitor 304 move the antenna impedance in opposite directions. If BST capacitor 304 has a large capacitance value, BST capacitor 304 itself will be the dominant tuning component in the matching network and the main trend of matching network will be to move down 352 the antenna impedance. If BST capacitor 304 has a small capacitance value, inductor L1 will be the dominant tuning component in the matching network and the main trend of the matching network will be to move up 354 the antenna impedance. Capacitor C1 is used to further tune 356 the impedance along the resistance circle on the Smith chart, so that it is moved close enough to the 50 Ohm (center of the Smith chart). As a result, the combined impedance of the antenna 306 and the impedance matching network of FIG. 3A can be matched to the impedance of the source 310.

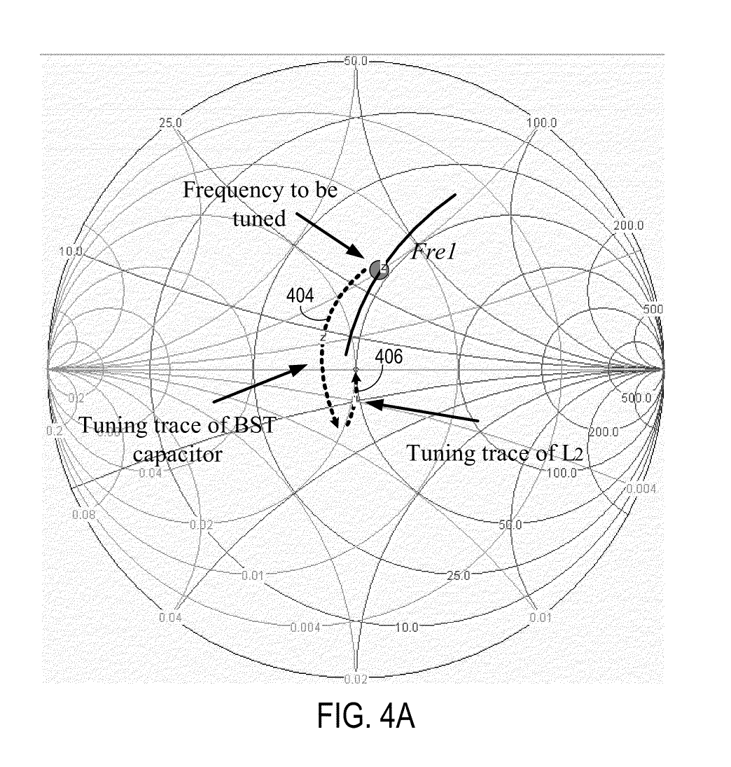

FIG. 4A illustrates a tuning trace of frequency Fre1 (see FIG. 1) when using the antenna matching network according to the embodiment shown in FIG. 2A. As mentioned above, if BST capacitor 204 has a small capacitance value, BST capacitor 204 itself will be the dominant tuning component in the matching network. Therefore, the main trend of the matching network will be to move down 404 the antenna impedance. The capacitance value of BST capacitor 204 is chosen such that it will move 404 Fre1 as close to 50 Ohm as possible along the resistance circle. Then, the inductor L2 is used to move 406 Fre1 even closer to 50 Ohm along the conductance circle.

FIG. 4B illustrates a tuning trace of frequency Fre3 (see FIG. 1) when using the antenna matching network according to the embodiment shown in FIG. 2A. In the example of FIG. 4B, BST capacitor 204 has a large capacitance value, and inductor L1 is the dominant tuning component in the matching network. Therefore, the main trend of the matching network is to move up 454 the antenna impedance. The value of inductor L1 will be chosen such that it will move frequency Fre3 as close to 50 Ohm as possible along resistance circle. Then, the inductor L2 is used to move 452 frequency Fre3 even closer to 50 Ohm along the conductance circle.

Several simulations were run to validate the embodiment of FIG. 2A.

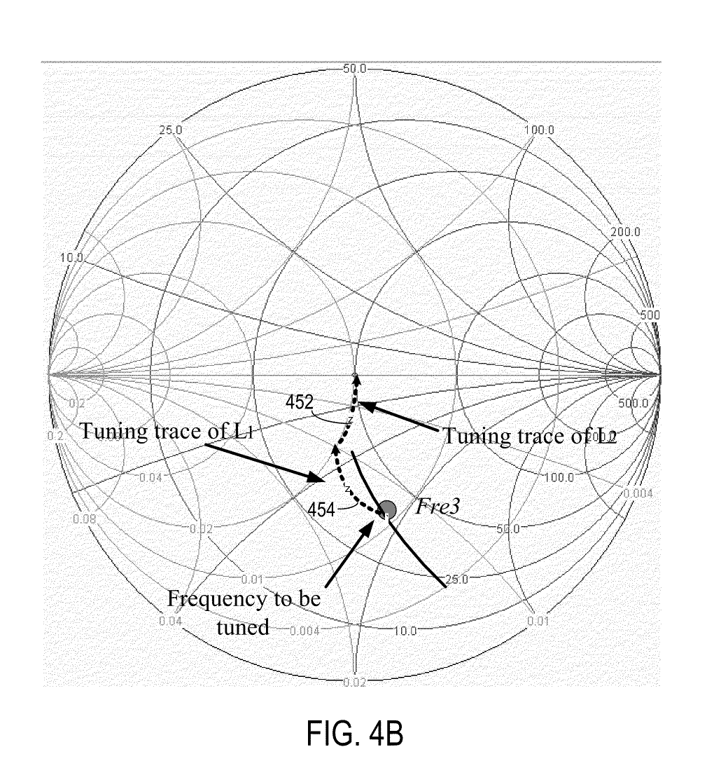

FIG. 5 illustrates simulated antenna impedance without a matching network. The impedance of frequency Fre2 is close enough to 50 Ohm and therefore considered matched. Two other frequencies, Fre1 and Fre3, were chosen on either side of Fre2. They are not considered matched to 50 Ohm since their impedance is not close enough to the center (50 Ohm).

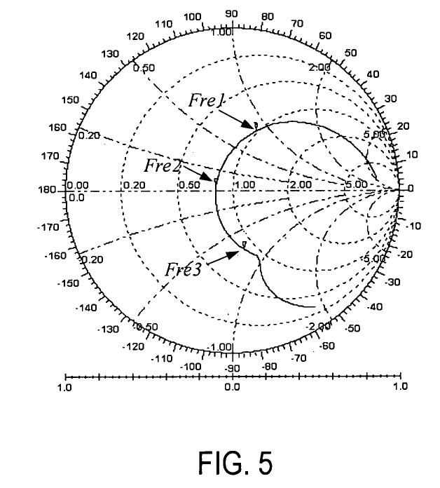

FIG. 6 illustrates frequency Fre1 being matched to 50 Ohm when the BST capacitor is the dominant component in a matching network of FIG. 2A. Therefore, the antenna impedance was moved down and frequency Fre1 was matched to 50 Ohm due to the BST capacitor and the inductor L2 (see FIG. 2A).

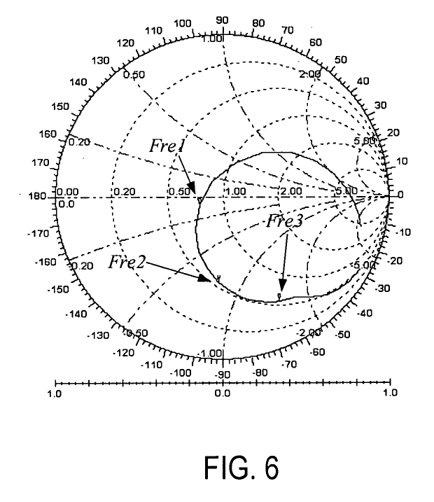

FIG. 7 illustrates frequency Fre3 being matched to 50 Ohm when the inductor L1 is the dominant component in a matching network of FIG. 2A. Inductor L1 is the dominant component in matching network. Therefore, antenna impedance was moved up and frequency Fre3 was matched to 50 Ohm due to inductors L1 and L2 (see FIG. 2A).

Thus, the matching network of FIG. 2A according to the present invention may be used to match impedances at different frequencies (Fre1 or Fre3), by adjusting the capacitance value of the BST capacitor in the matching network of FIG. 2A. The capacitance value of the BST capacitor may be adjusted by adjusting the DC bias voltage 208 applied to the BST capacitor in the matching network of FIG. 2A.

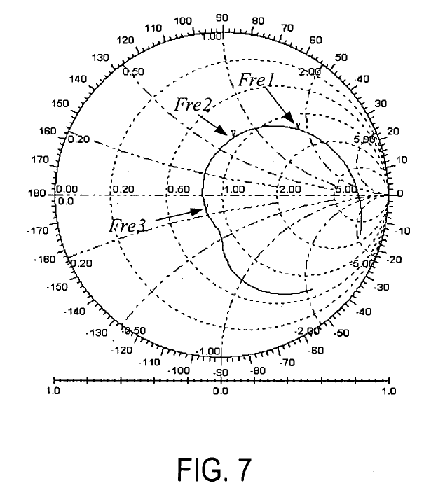

FIG. 8 illustrates a typical metal-insulator-metal (MIM) parallel plate configuration of a thin film BST capacitor according to one embodiment of the present invention. Such BST capacitor 800 may be used as the tunable BST capacitor 204 in FIG. 2A or tunable BST capacitor 304 in FIG. 3A. Referring to FIG. 8, the capacitor 800 is formed as a vertical stack comprised of a metal base electrode 810b supported by a substrate 830, BST dielectric 820, and a metal top electrode 810a. The lateral dimensions, along with the thickness of the BST dielectric 820, determine the capacitance value of the BST capacitor 800.

BST generally has a high dielectric constant so that large capacitances can be realized in a relatively small area. Furthermore, BST has a permittivity that depends on the applied electric field. As a result, voltage-variable capacitors (varactors) can be produced by changing a DC bias voltage across the BST capacitor. In addition, the bias voltage of the BST capacitor 800 can be applied in either direction across a BST capacitor since the film permittivity is generally symmetric about zero bias. That is, BST dielectric 820 does not exhibit a preferred direction for the electric field. One further advantage is that the electrical currents that flow through BST capacitors are relatively small compared to other types of semiconductor varactors.

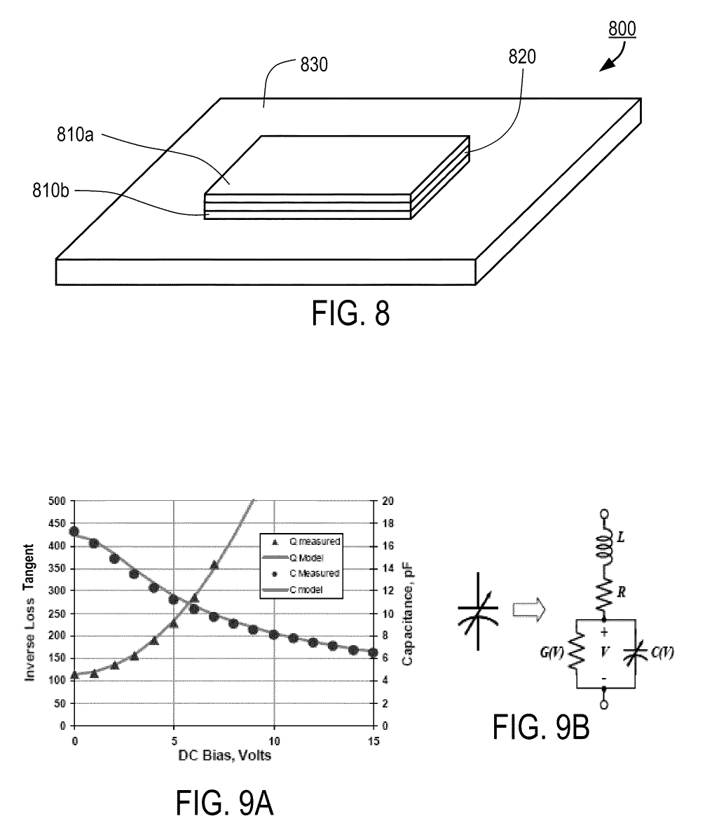

FIG. 9A is a graph illustrating a typical tuning curve for the BST capacitor 800. FIG. 9A shows the dependence of both capacitance and dielectric loss (inverse loss tangent) of the BST capacitor 800 upon the DC bias voltage applied to the BST capacitor 800. As shown in FIG. 9A, the capacitance (C) of the BST capacitor 800 decreases from approximately 16.5 pF to approximately 6 pF as the DC bias voltage applied to the BST capacitor 800 varies from 0 volt to 15 volt. Also, the inverse of the loss tangent (i.e., Q_{BST}=1/tan δ) is greater than 100. Thus, the capacitance of the BST capacitor 800 can be tuned by simply changing the DC bias voltage applied to the BST capacitor 800.

FIG. 9B is an equivalent circuit model for the BST capacitor of FIG. 8. The model in FIG. 9B captures the loss elements and the large signal properties of the BST capacitor 800. The material non-linearities are described by the parallel combination of the conductance G(V) and the capacitance C(V). An empirical model that adequately defines the C-V and Q-V tuning curves of FIG. 9A is given by:

$$C ( V ) = \frac{{C}_{0}}{\sqrt[3]{1 + {( V / {V}_{m} )}^{2}}}$$

$$G ( V ) = \frac{ω C ( V )}{{Q}_{BST} ( V )}$$

$${Q}_{BST} ( V ) = \frac{1}{tan δ} = {Q}_{0} ( 1 + {qV}^{2} )$$

where C₀, Vₘ, Q₀ and q are fitting parameter constants. The simulation results for this model is shown in FIG. 9A as well, overlayed with the actual measured results. The thickness and material composition (Ba/Sr ratio) of the BST layer 820 are primary factors in determining the tunability at a given voltage and hence Vₘ. The film quality factor Q_{BST} can be determined from low-frequency (1 MHz) impedance measurements or by extrapolating on-wafer RF data to low frequencies. The high-frequency loss of the BST capacitor 800 depends on both the loss tangent of the dielectric 820 and the conductor loss of the metal layers 810a, 810b, modeled by the series resistance R in FIG. 9B. A Q-factor can be associated with the conductor loss alone, denoted as Q_{c}, in which case the overall Q-factor of the BST capacitor 800 and the series resistance can be written as:

$$\frac{1}{{Q}_{total}} = \frac{1}{{Q}_{c}} + \frac{1}{{Q}_{BST}} and R = \frac{1}{ω {Q}_{c} C} .$$

The series inductance L can be determined by measurement of the self-resonant frequency of the BST capacitor 800, with the stray reactive parasitic capacitance arising from on-wafer probe contacts removed.

Upon reading this disclosure, those of skill in the art will appreciate still additional alternative designs for a tunable antenna impedance matching network. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A tunable impedance matching circuit coupled between a signal source and an antenna, the tunable impedance matching circuit comprising:
a variable capacitor coupled in series to the signal source, a capacitance of the variable capacitor being adjustable according to a bias voltage applied to the variable capacitor;
a first inductor coupled in series to the variable capacitor and the antenna; and
a second inductor coupled to a node between the variable capacitor and the first inductor,
wherein a combined impedance of the tunable impedance matching network and the antenna is tunable to match an impedance of the signal source by adjusting the bias voltage applied to the variable capacitor.

2. The tunable impedance matching circuit of claim 1, wherein the variable capacitor is a BST (Barium Strontium Titanate) capacitor including BST as dielectric.

3. The tunable impedance matching circuit of claim 1, wherein the variable capacitor is a dominant tuning component in the tunable impedance matching circuit.

4. The tunable impedance matching circuit of claim 1, wherein the first inductor is a dominant tuning component in the tunable impedance matching circuit.

5. The tunable impedance matching circuit of claim 1, wherein:
a first terminal of the variable capacitor is coupled to the signal source and the bias voltage, and a second terminal of the variable capacitor is connected to both the first inductor and the second inductor;
a first terminal of the first inductor is coupled to the second terminal of the variable capacitor and to the second inductor, and a second terminal of the first inductor is connected to the antenna; and
a first terminal of the second inductor is connected to the second terminal of the variable capacitor and the first terminal of the first inductor, and a second terminal of the second inductor is connected to ground.

6. The tunable impedance matching circuit of claim 1, wherein the bias voltage is a DC voltage coupled to the variable capacitor via a DC bias resistor.

7. The tunable impedance matching circuit of claim 6, further comprising a DC blocking capacitor coupled in series to the signal source to block the DC voltage from reaching the signal source.

8. A tunable impedance matching circuit coupled between a signal source and an antenna, the tunable impedance matching circuit comprising:
a first, variable capacitor coupled in parallel to the signal source, a capacitance of the first, variable capacitor being adjustable according to a bias voltage applied to the first, variable capacitor;
an inductor coupled in parallel to the variable capacitor; and
a second capacitor coupled between the first, variable capacitor and the inductor,
wherein a combined impedance of the tunable impedance matching network and the antenna is tunable to match an impedance of the signal source by adjusting the bias voltage applied to the first, variable capacitor.

9. The tunable impedance matching circuit of claim 8, wherein the first, variable capacitor is a BST (Barium Strontium Titanate) capacitor including BST as dielectric.

10. The tunable impedance matching circuit of claim 8, wherein the first, variable capacitor is a dominant tuning component in the tunable impedance matching circuit.

11. The tunable impedance matching circuit of claim 8, wherein the inductor is a dominant tuning component in the tunable impedance matching circuit.

12. The tunable impedance matching circuit of claim 8, wherein:
a first terminal of the first, variable capacitor is coupled to the signal source and to the bias voltage, and a second terminal of the variable capacitor is connected to ground;
a first terminal of the second capacitor is connected to the first terminal of the variable capacitor, and the second terminal of the second capacitor is connected to both the inductor and the antenna; and
a first terminal of the inductor is connected to the second terminal of the second capacitor and to the antenna, and a second terminal of the inductor is connected to ground.

13. The tunable impedance matching circuit of claim 8, wherein the bias voltage is a DC voltage coupled to the first, variable capacitor via a DC bias resistor.

14. The tunable impedance matching circuit of claim 13, further comprising a DC blocking capacitor coupled in series to the signal source to block the DC voltage from reaching the signal source.
